(19) United States
(12) Patent Application Publication
(10) Pub. No.: US 2013/0132161 A1
(43) Pub. Date: May 23, 2013

(54) Determining Maturity Status of An Organization In A Technology Area

(71) Applicants: Santosh Kumar MOHANTY, Mumbai (IN); Nisha SHARMA, Mumbai (IN); Santha SUBRAMONI, Bangalore (IN)

(72) Inventors: Santosh Kumar MOHANTY, Mumbai (IN); Nisha SHARMA, Mumbai (IN); Santha SUBRAMONI, Bangalore (IN)

(73) Assignee: TATA CONSULTANCY SERVICES LIMITED, Mumbai (IN)

(21) Appl. No.: 13/407,211

(22) Filed: Feb. 28, 2012

(30) Foreign Application Priority Data
Nov. 19, 2011 (IN) 3255/MUM/2011

(51) Int. Cl. G06Q 10/06

(52) U.S. Cl. 705/7.36

(57) ABSTRACT

Systems and methods for determining a maturity status of an organization in a technology area are provided. The system comprises a processor and a memory coupled to the processor. The memory comprises a definition module configured to define a Technology Service Maturity Model (TSMM). The TSMM comprises a set of maturity levels indicating at least one of an aspired proficiency level and a current proficiency level of the organization in the technology area. The TSMM further comprises a set of capability attributes for each of the maturity levels. The set of capability attributes comprises at least one of competency, asset, delivery, pre-sales, collaboration, and branding. The system further comprises an assessment module configured to determine the maturity status of the organization in the technology area based upon the set of capability attributes possessed by the organization in the each of the maturity levels.

### CROSS REFERENCE TO RELATED APPLICATION

This application claims priority under 35 U.S.C. §119 to Indian Application No. 3255/MUM/2011, filed on Nov. 19, 2011, the entirety of which is incorporated herein by reference.

### TECHNICAL FIELD

The present subject matter described herein, in general, relates to systems and methods for determining a maturity status of an organization in a technology area.

### BACKGROUND

A lot of organizations are increasingly depending on technology as a backbone for growth and long term sustainability. Emergence of new technology areas and transformation of existing technologies is occurring at a fast pace. As a result, significant challenges exist for those organizations that do not efficiently and effectively manage technology. Presently, organizations, such as Information Technology (IT) organizations deal with a plurality of product and service technology areas. Therefore, it is important for such organizations to pay attention to building, maintaining, and enhancing their capabilities in providing services in the plurality of technology areas in a systematic manner in order to attend to organizational and customer needs.

### SUMMARY

This summary is provided to introduce concepts related to determining a maturity status of an organization in a technology area and the concepts are further described below in the detailed description. This summary is not intended to identify essential features of the claimed subject matter nor is it intended for use in determining or limiting the scope of the claimed subject matter.

In one implementation, a system for determining a maturity status of an organization in a technology area is provided. The system comprises a processor and a memory coupled to the processor. The memory comprises a definition module configured to define a Technology Service Maturity Model (TSMM). The TSMM comprises a set of maturity levels indicating at least one of an aspired proficiency level and a current proficiency level of the organization in the technology area. The TSMM further comprises a set of capability attributes for each of the maturity levels. The set of capability attributes comprises at least one of competency, asset, delivery, pre-sales, collaboration, and branding. The system further comprises an assessment module configured to determine the maturity status of the organization in the technology area based upon the set of capability attributes possessed by the organization in the each of the maturity levels.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network implementation of a system for determining a maturity status of an organization in a technology area, in accordance with an embodiment of the present subject matter.

FIG. 2 is a pictorial representation of a technology service maturity model illustrating a mapping of a 5E maturity model with a 5I maturity model, a 5P maturity model, and a 5L maturity model, in accordance with an embodiment of the present subject matter.

FIG. 3 is a template for describing a set of capability attributes and benefits for a set of stakeholders at a maturity level, in accordance with an embodiment of the present subject matter.

FIG. 4 is a template for describing a set of activities to be performed at each capability attribute for a maturity level, in accordance with an embodiment of the present subject matter.

FIG. 5 shows activity counts for a given maturity level and corresponding capability attributes, in accordance with an embodiment of the present subject matter.

FIG. 6A to 6C show assessment reports of an organization in a technology area, in accordance with an embodiment of the present subject matter.

FIG. 7 shows a flowchart illustrating a method for determining a maturity status of an organization in a technology area, in accordance with an embodiment of the present subject matter.

### DETAILED DESCRIPTION

System and method for determining a maturity status of an organization in a technology area are described herein. Technology areas refer to areas in which the organization provides services and, thus, may include service technology areas, such as HR, finance and cloud computing, and product technology areas, such as SAP and Oracle. In one implementation, an organization may focus on certain technology areas only if the technology areas bring benefit to stakeholders. To deliver the benefit to the stakeholders, the organization needs to focus on building capability in the technology areas. It is to be understood that the capability has to mature on a fast track over a time period to maximize benefit for the stakeholders.

In one implementation, the organization may wish to focus on a technology area, such as cloud computing. In order to judge how the organization is learning, leveraging, and becoming an expert in the technology area, a Technology Service Maturity Model (TSMM) may be defined. The TSMM may be used to determine the maturity status of the organization in a technology area. The TSMM may also suggest ways to move step by step in order to attain maturity in the technology area. Specifically, if the organization decides to focus on a particular technology area, then the TSMM may suggest how the organization should plan in order to mature as a service provider in that particular technology area and become a market leader.

In the present subject matter, the TSMM may include a set of maturity levels. The set of maturity levels indicate at least one of an aspired proficiency level and a current proficiency level of the organization in a given technology area. The TSMM may also include a set of capability attributes for each of the maturity levels. The set of capability attributes is a skill set that can be used by the organization to build or demonstrate different levels of capabilities, in the given technology area, corresponding to the different maturity levels. Further, the TSMM may also include a benefit dimension indicating benefits for a set of stakeholders at each of the maturity levels. The set of stakeholders may be benefited when the organization acquires the set of capabilities defined for each of the maturity levels in the given technology area. The stakeholders may include the organization, customers, and employees. The benefits, at each of the maturity levels, are realized for each stakeholder both from a lag perspective and a lead perspective, and hence may be assessed based on a lag indicator and a lead indicator. The lag indicator at each maturity level corresponds to benefits realized after an organization has attained the maturity level. In one implementation, the lag indicator levels correspond to 5P maturity model, namely, presence, penetration, performance, perfect, and prime. The lead indicator at each maturity level corresponds to benefits that occur while an organization is in the process of attaining the maturity level. In one implementation, the lead indicator levels correspond to 5L maturity levels, namely, learning, leveraging, learned, leveraged, and leader.

The TSMM may recommend a set of activities for each of the capability attributes in each of the maturity levels to be performed by the organization in order to attain a maturity level. The TSMM may further include a set of measurement guidelines for measuring the set of activities performed by the organization, thereby assisting in determining a maturity status of the organization in the given technology area.

Further, after defining the set of capability attributes and the benefits for the set stakeholders at each of the maturity levels, the system may generate assessment reports based upon a set of rules. The assessment reports may be analyzed to align a focus of the organization with business goals.

While aspects of described system and method for determining a maturity status of an organization in a technology area may be implemented in any number of different computing systems, environments, and/or configurations, the embodiments are described in the context of the following exemplary system.

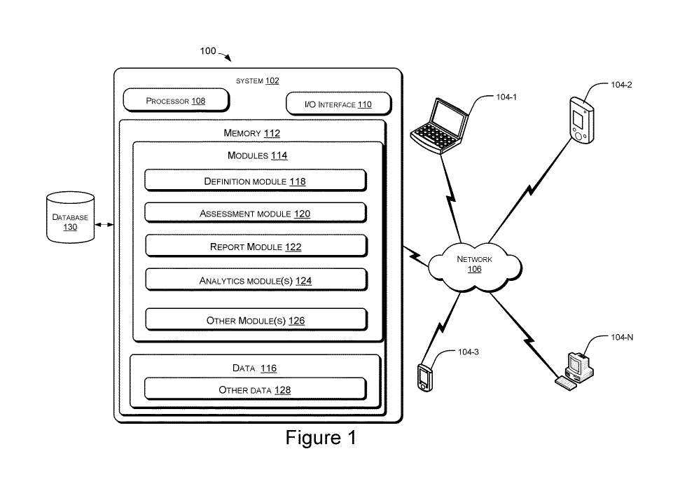

Referring now to FIG. 1, a network implementation 100 of a system 102 for determining a maturity status of an organization in a technology area is illustrated, in accordance with an embodiment of the present subject matter. Further, the system 102 may be implemented in a variety of computing systems, such as a laptop computer, a desktop computer, a notebook, a workstation, a mainframe computer, a server, a network server, and the like. It will be understood that the system 102 may be accessed by the employees of the organization through one or more client devices 104-1, 104-2, . . . 104-N, collectively referred to as client devices 104 hereinafter, or applications residing on client devices 104. Examples of the client devices 104 may include, but are not limited to, a portable computer, a personal digital assistant, a handheld device, and a workstation. The client devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an I/O interface 110, and a memory 112. The at least one processor 108 may be implemented as one or more microprocessors, microcomputers, microcontrollers, digital signal processors, central processing units, state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with a user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 112 may include modules 114 and data 116.

The modules 114 include routines, programs, objects, components, data structures, etc., which perform particular tasks or implement particular abstract data types. In one implementation, the modules 114 may include a definition module 118, an assessment module 120, a report module 122, an analytics module 124, and other modules 126. The other modules 126 may include programs or coded instructions that supplement applications and functions of the system 102.

The data 116, amongst other things, serves as a repository for storing data processed, received, and generated by one or more of the modules 114. The data 116 may also include other data 128. The other data 128 may include data generated as a result of the execution of one or more modules in the other module 126.

In one embodiment, the system 102 helps in determining a maturity status of an organization in a technology area. Examples of the organization may include an IT organization, a product manufacturing organization, a telecommunication organization, or other large conglomerates. The present subject matter may be explained mainly considering the organization to be an IT organization; however, it will be appreciated by a person skilled in the art that the organization may be any organization involved in any line of business.

In one implementation, the system 102 may build and use a Technology Service Maturity Model (TSMM) for determining the maturity status of an organization in a technology area. Further, in one implementation, the TSMM may be stored in a database 130 that is connected to the system 102 and the various modules in the modules 114, as shown in FIG. 1. Although in the present embodiment the database 130 is shown to be outside the system 102, in another embodiment, the database 130 may be a part of the system 102.

In one implementation, the definition module 118 may be configured to define the TSMM. Technology areas refer to areas in which the organization provides services and, thus, may include service technology areas, such as HR, finance and cloud computing, and product technology areas, such as SAP and Oracle. In the present implementation, the TSMM may comprise a set of maturity levels, a set of capability attributes, and a benefit dimension. The set of maturity levels corresponds to the different levels of proficiency that an organization may possess as it develops capabilities in providing services in a technology area. For example, the organization may either be a new entrant or a reasonably experienced player or a veteran in a technology area. Therefore, in the order to assess the maturity status of the organization in a technology area, the set of maturity levels are defined.

In one implementation, the set of maturity levels may be built around a 5E maturity model where different levels of maturity in the 5E maturity model correspond to the different proficiency levels. The levels in the 5E maturity model include an emerge level, an engage level, an establish level, an excel level, and an excite level. A level of proficiency of the organization in a technology area increases as the organization moves from the emerge level to the excite level. In order to attain maturity in each of the maturity levels, the organization needs to have certain capabilities. Such capabilities are defined in the set of capability attributes. The set of capability attributes is a skill set that can be used by the organization to build or demonstrate different levels of capabilities in the given technology area corresponding to the different maturity levels. In one implementation, the set of capability attributes includes at least one of competency, asset, delivery, pre-sales, collaboration, and branding.

Consider that the organization wishes to enter into a technology area, such as cloud computing, for providing services. In order to enter into the cloud computing market, the organization would typically begin with pre-sales. During pre-sales, the organization would aim at convincing and converting a customer. For this, the customer should gain trust in the organization during pre-sales. After the customer is converted, the organization should deliver services or products of right quality within a predetermined time, so that the commitments made at the time of pre-sales are met and the organization can become a trusted service provider. In other words, the organization should posses skills related to delivery. Further, in order to do the pre-sales and delivery properly, the organization may posses some assets. Example of assets may include software, requirements gathering templates, checklists, and the like. Assets help in ensuring that all requirements from the customer are gathered properly, quality control processes are in place and that the product delivered covers all the requirements of the customer. Therefore, assets help in timely delivery and quality assurance.

Further, for delivering a project assigned by the customer, the organization should posses certain competencies. The competencies may relate to business skills, technical skills, customer handling capabilities, leadership skills, innovation skills, non-technology skills, such as communication skills, and the like. Also, to make use of competencies available with different resources, the employees may have to collaborate to obtain synergies from working as a team. The collaboration may be internal or/and external. For example, in internal collaboration, the employees of the organization may work together as a team despite being placed at different locations or in different business units. In external collaboration, the employees may need to collaborate with the customer, vendors, universities, etc., for delivery of the project. For example, the customer may help in training the employees in case the technology area is new. Further, to attract good projects and build reputation in the technology area, the organization may undertake branding related activities. In one example, the organization may publicize an appreciation received from the customer, a maturity level that the organization has achieved in the technology area, market share of the organization, and the like. Therefore, as mentioned above, the set of capability attributes may help the organization to assess its current maturity level and plan on how it may move from one maturity level to another.

In one implementation, the set of capability attributes may be built, assessed and matured in the organization using a 5I maturity model, where the different levels of capabilities in the 5I maturity model correspond to the different maturity levels. The levels in the 5I maturity model include intent, initiate, initiative, internalize, and innovate. The 5I maturity model may help the organization in scaling up the set of capability attributes in a systematic and structured manner in terms of depth, breadth, market visibility, and market recognition. Specifically, as per the 5I maturity model, the organization shows an intent to develop the set of capability attributes when the maturity level is at the emerge level. In one example, the organization may show the intent to develop the set of capabilities in a technology area by considering future prospects of the technology area and an amount of revenue that may be generated by providing services in the technology area. To move to the next maturity level, i.e., engage level, the organization would have to initiate the development of the set of capability attributes. In one example, the organization may initiate the development by participating in seminars, creating a business plan, talking to a technology partners, talking to top management, and the like.

An organization that is at the next maturity level, i.e., establish level, would drive initiatives to develop the set of capability attributes. In one example, the organization may take initiatives by putting in place processes and structures to proactively support pre-sales and delivery, and to efficiently scale-up its capabilities. Furthermore, as per the 5I maturity model, the organization would ensure internalization of the initiatives across its ecosystem with equal effectiveness by building the set of capability attributes to achieve the excel level. In one example, the organization may ensure internalization by having widespread recognition of its capabilities in providing services in the technology area and of the skills of the employees working in the technology area, both internally and externally. Furthermore, in order to move to a final maturity level, i.e., excite level, the organization would have to build the capability to innovate to develop new market opportunities, create intellectual property and assert itself as a leader in the technology area.

Therefore, it may be understood that the 5I maturity model may be used to develop the set of capability attributes in each of the maturity levels. Further, the set of capability attributes may be developed for each of the maturity levels so as to benefit a set of stakeholders. Aligning the set of capability attributes to benefit the set of stakeholders ensures that the investment is aligned to business results. In one implementation, the benefit dimension included in the TSMM may indicate benefits for the set of stakeholders, such as an employee or individual in the organization, a customer of the organization, and the organization itself. In one implementation, the benefits, at each of the maturity levels, are realized for each stakeholder both from a lag perspective and a lead perspective, and hence may be assessed based on a lag indicator and a lead indicator. The lag indicator at each maturity level corresponds to benefits realized after an organization has attained the maturity level. In one implementation, the lag indicator levels correspond to 5P maturity model, namely, presence, penetration, performance, perfect, and prime. The lag indicators may be used to plan and assess a growth in maturity level from a prematurity stage to a market leader stage. For example, when the organization reaches the Emerge maturity level, the organization would have a presence in the market with respect to the technology area, and hence the lag indicator is market presence. Subsequently, the organization may penetrate in the market by trying to capture more customers. Thereafter, the organization may show performance by delivering right quality of service and/or product within a pre-decided time. Subsequently, the organization may perfect itself in the technology area, and finally the organization may become a prime player in the market for the technology area.

On the other hand, the lead indicators at each maturity level correspond to benefits that occur while an organization is in the process of attaining the maturity level and can be used to ensure that the organization is on the right track towards becoming a prime player in the market. In one implementation, the lead indicators are based on a 5L maturity model comprising learning, leveraging, learned, leveraged, and leader. In the present implementation, as per the lead indicators, the organization grows from first learning, to then leveraging the learning, and then to implementing the learning in a scalable and structured manner. Subsequently, the structured learning gained by the team is leveraged. In the end, the organization becomes a market leader. Therefore, the lag indicators and the lead indicators are used to indicate the benefits realized by the set of stakeholders.

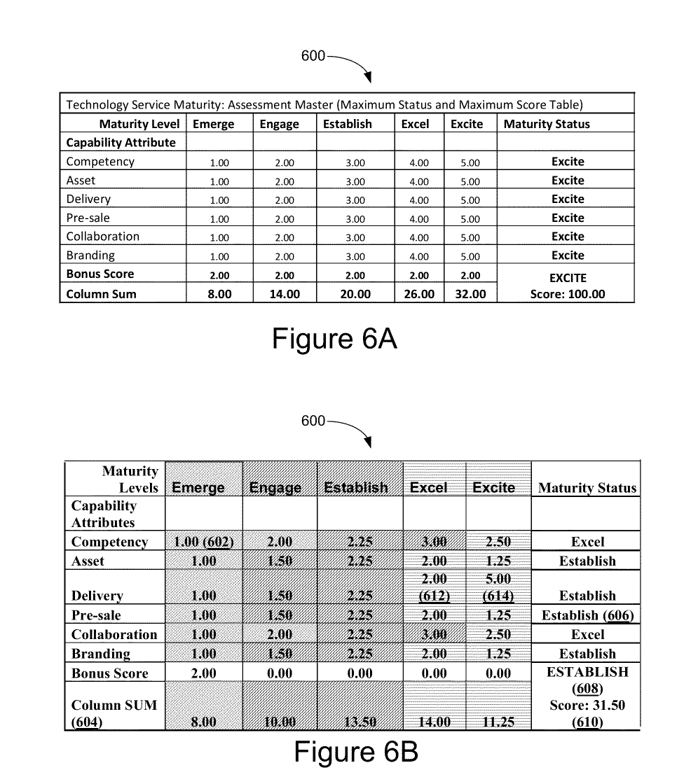

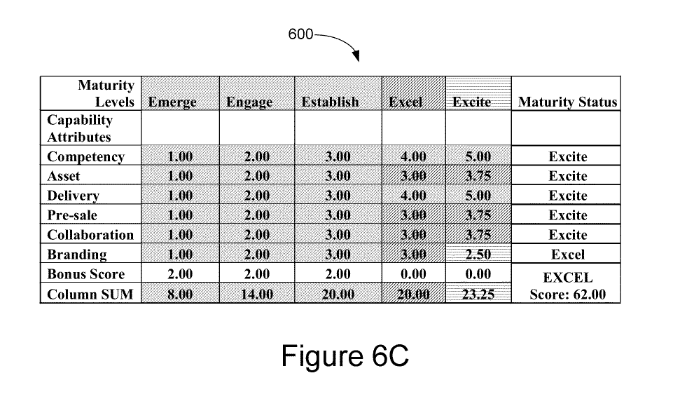

As mentioned above, the system 102 also includes the assessment module 120, the report module 122, and the analytics module 124. The assessment module 120 is configured to determine the maturity status of the organization in a technology area based upon the set of capability attributes possessed by the organization in the each of the maturity levels. The report module 122 is configured to generate assessment reports based on a set of rules, as will be described later. Further, the analytics module 124 is configured to determine a pattern of weak points and a pattern of good points from the assessment reports in order to help in taking corrective actions. For example, the analytic module 124 may analyze the assessment reports (described later with reference to FIGS. 6A-6C) and share an observation that the organization has to improve its branding capability across a technology service area. Similarly, in another example, by analyzing the maturity levels in the assessment reports, the analytics module 124 may provide the observation to strengthen asset capability for a technology area.

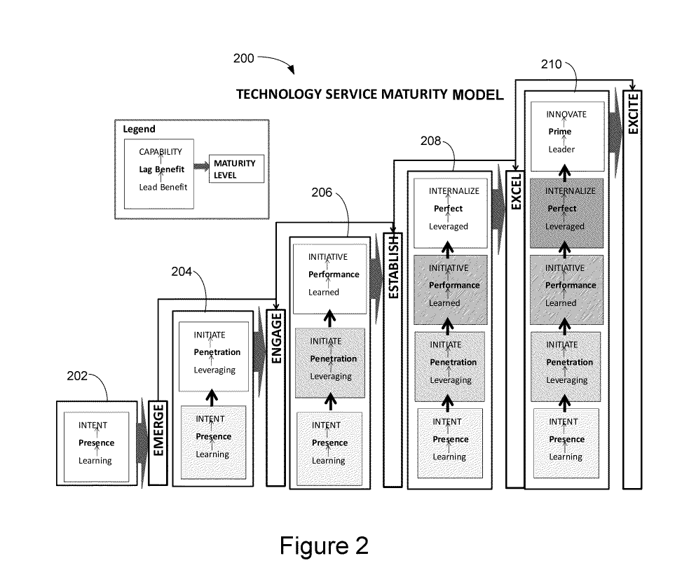

The TSMM, as described above, may be summarized and represented as shown in FIG. 2. FIG. 2 shows a pictorial representation 200 of a technology service maturity model illustrating a mapping of the 5E maturity model with the 5I maturity model, the 5P maturity model, and the 5L maturity model. Specifically, block 202 in FIG. 2 shows that in order to be in the emerge level, the organization should a) have an intent to focus on a technology area, b) have some presence in a market corresponding to the technology area, and c) be learning the technology area in order to move to a next level of proficiency in the technology area. Further, block 204 shows that in order to be in the engage level, the organization should a) initiate to develop the set of capability attributes, b) try to penetrate into the market, c) be leveraging the learning of the technology area in order to move to a next level of proficiency in the technology area. Furthermore, block 206 shows that in order to be in the establish level, the organization should a) take initiative to develop the set of capability attributes, b) perform well in the technology area, c) have learned the technology area well in order to move to a next level of proficiency in the technology area. Similarly, blocks 208 and 210 indicate steps to be taken by the organization in order to be in the excel level and excite level, respectively.

As mentioned above, the definition module 118 is configured to define the set of capability attributes and the benefits for the set of stakeholders for each of the maturity levels in the TSMM. In order to systematically define the set of capability attributes and the benefits to the set of stakeholders, a template may be used.

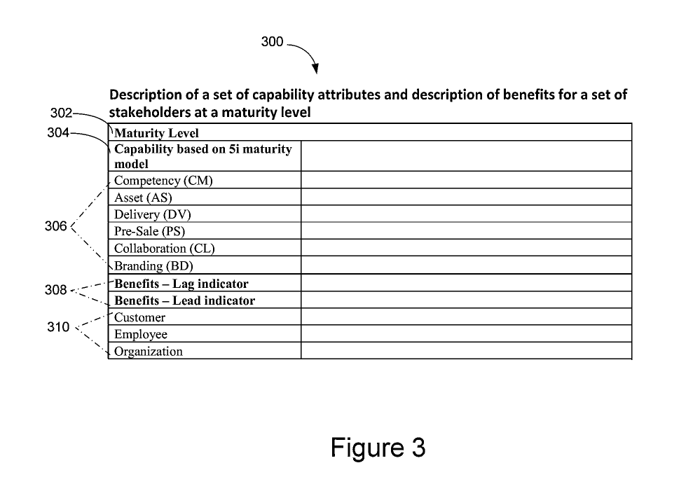

FIG. 3 shows a template 300 for defining the set of capability attributes and the benefits for the set of stakeholders at a maturity level, in accordance with an embodiment of the present subject matter. Specifically, the template 300 comprises a row 302 for indicating a maturity level, a row 304 for indicating a corresponding 5I maturity model on which a capability is based, rows 306 for describing the set of capability attributes, rows 308 for describing the lag indicator and the lead indicator, and rows 310 for describing the set of stakeholders. In one implementation, the template 300 may be used as shown in Table 1 below.

Table 1 describes the set of capability attributes and the benefits for the set of stakeholders at the emerge level of the set of maturity levels. Specifically, Table 1 shows that, at the emerge level, the organization has an intent to focus on a technology area as the organization envisions good business opportunity in the technology area. In one example, the organization may show the intent to develop the set of capability attributes in cloud computing considering future prospects of cloud computing. As shown in Table 1, the set of capability attributes, such as competency, asset, delivery, pre-sales, collaboration, and branding are described for the emerge level. Specifically, the Table 1 suggests that in the emerge level, the competency needs to be identified and processes need to be defined to attain the competency. Further, the assets, such as checklists, templates, software, and delivery documents, may be identified and/or created. Furthermore, during delivery, a proof-of-concept may be created and pilot projects may be received from the customer. For example, the organization may provide discounts for the pilot project or may even do the pilot projects for free. Further, the organization may also assure the customer of quality and timely delivery. Furthermore, during presales, the organization may enquire about opportunities in the technology area, i.e., cloud computing, and also choose a customer base. The organization may also choose to cross-sell to existing customers or go to new potential customers by formulating a sales strategy. Further, in pre-sales, the organization may prepare presentations to attract customers and ask the customers for pilot projects.

Further, during collaboration, the organization may collaborate with technology partners and HR for training and staffing opportunities. Specifically, the organization may request the HR to provide potential candidates who can actually start working/learning in the technology area. Furthermore, for branding, the organization may identify core people and position them in key opportunities. The organization may start marketing the pilot projects done for the customers in order to attract new potential customers.

Table 1 also shows the lag indicator and lead indicator definitions. Specifically, for the emerge level, the lag indicator is ‘presence’ and the lead indicator is ‘learning’. Further, Table 1 also describes the benefits realized by the set of stakeholders, such as customer, employee, and the organization. Table 1 suggests that when the organization is at the emerge level, the customer should feel satisfied by the project delivery even if the project was a pilot project. Further, the customer should provide feedback on at least the key people working on the project. The feedback received from the customer may help in assessing the capability of the team working on the project. Further, the customer should also appreciate the investment of time and effort by the organization.

Table 1 also describes the benefits for the employee. In one example, the employee may have an opportunity to learn the technology area. The employee should feel that the technology area has reasonable future prospects. The employee also gets a chance to define processes as the technology area is new. The employee may also participate in justifying a business case for focusing in the technology area. The employee may justify the business case by studying market potential, expected demand, citing cases of competition which is also focusing on the same technology area, and using other methods as will be understood. Further, table 1 also describes the benefits for the organization. Specifically, the organization is able to enter into a new technology area, attract interested people, and invest in planning for growth. Therefore, it may be understood that Table 1 succinctly describes the set of capability attributes and the benefits for the set of stakeholders at the emerge level.

Similarly, Table 2 as shown below succinctly describes the set of capability attributes and the benefits for the set of stakeholders in the engage level. Specifically, Table 2 shows that the organization has moved on to the next level of maturity, i.e., engage level and is penetrating into the market with respect to a technology area. To penetrate into the market, the organization takes initiations in the engage level. Table 2 also shows that the organization is leveraging the learning received in the emerge level. Similarly, Tables 3-5 as shown below succinctly describe the set of capability attributes and the benefits for the set of stakeholders in the establish level, the excel level, and the excite level, respectively.

TABLE 1
Description of the set of capability attributes and description of benefits for the set of
stakeholders at the emerge level of maturity:
Maturity Level—Emerge (EM) level

| | |
|---|---|
| The set of capability | Organization has an intent to focus (INTENT) on a technology |
| attributes | area |
| Competency (CM) | Identify need & define process |
| Asset (AS) | Identify need & define process |
| Delivery (DV) | Create Proof-of-Concept (PoC) and Pilot Projects |
| Pre-Sales (PS) | Enquire opportunity in chosen market and customer base |
| Collaboration (CL) | Collaborate with partner and HR for training and staffing opportunities |
| Branding (BD) | Identify core people & position them in key opportunities |
| Benefits—Lag | Organization has shown presence in the technology area |
| indicator | (PRESENCE) |
| Benefits—Lead | Organization starts learning in a systematic way (LEARNING) |
| indicator | |
| Customer | Satisfaction in project delivery |
| | Feedback on Key People |
| | Appreciate the investment by the organization in the technology area |
| Employee | Opportunity to learn the technology area |
| | Opportunity to define processes |
| | Participate in justifying business case for focusing in the technology |
| | area |
| Organization | Entry to the technology area |
| | Attracting interested people |
| | Investment and planning for growth |

TABLE 2
Description of the set of capability attributes and description of benefits for
the set of stakeholders at the engage level of maturity:
Maturity Level—Engage (EN) level

| | |
|---|---|
| The set of capability | Organization has initiated steps (INITIATE) |
| attributes | |
| Competency (CM) | Assessment and train-to-trainer (T3) training |
| Asset (AS) | Build and start managing inventory of assets for |
| | consulting and delivery |
| Delivery (DV) | Adequate engagements in hand for consulting, |
| | implementation and support |
| Pre-Sale (PS) | Contribute to winning deals through good solution |
| | proposals |
| Collaboration (CL) | Collaboration with partners and projects in supporting |
| | delivery and asset building |
| Branding (BD) | Key assets are positioned and recognized |
| Benefits—Lag | Organization gains Penetration (PENETRATION) |
| indicator | |
| Benefits—Lead | Organization starts Leveraging the capability attributes |
| indicator | (LEVERAGING) |
| Customer | Quality-of-Services (QoS) in project delivery |
| | Feedback on T3 & Training |
| | Feedback on Asset usage |
| Employee | Aspire for T3 trainer |
| | Build competency in core and complementary area |
| | Build assets and use existing assets appropriate for |
| | opportunity |
| Organization | Impact on T3, training & asset |
| | Impact on opportunity win-loss ratio and quality of |
| | opportunity |
| | Impact on delivery assurance |

TABLE 3
Description of the set of capability attributes and description of benefits
for the set of stakeholders at the establish level of maturity:
Maturity Level—Establish (ES) level

| | |
|---|---|
| The set of capability | Organization has taken initiative to create impact |
| attributes | (INITIATIVE) |
| Competency (CM) | Structured program to support pre-sale and delivery |
| Asset (AS) | Program for Asset leverage—reuse, reference and |
| | creation |
| Delivery (DV) | Solution and process driven delivery |
| Pre-Sale (PS) | Solution based project wins |
| Collaboration (CL) | Strong community culture and capability to support |
| | pre-sale and delivery |
| Branding (BD) | Positive mindshare with technology partners |
| Benefits—Lag | Organization achieves business performance |
| indicator | (PERFORMANCE) |
| Benefits—Lead | Organization gains through scalable and structured |
| indicator | Learning (LEARNED) |
| Customer | Quality of Experience (QoE) in project delivery |
| | Recognition of key people in the engagement |
| | Recognition of solution and asset used in the |
| | engagement |
| Employee | Contribution to delivery |
| | Contribution to pre-sale |
| | Building partner relationship |
| Organization | Impact on delivery acceleration and quality |
| | Ability to baseline the productivity baseline and |
| | setting target |
| | Trust of technology partner and investment in |
| | capability building |

TABLE 4
Description of the set of capability attributes and description of benefits for the
set of stakeholders at the excel level of maturity:
Maturity Level—Excel (EL) level

| | |
|---|---|
| The set of capability | Organization has internalized the capability in the technology area |
| attributes | (INTERNALIZE) |
| Competency (CM) | Acceptance and visibility of the technology area within the |
| | organization |
| Asset (AS) | Every asset is assessed on productivity and economic value |
| Delivery (DV) | Certainty experienced by customer during delivery life cycle |
| Pre-Sale (PS) | Winning multi-technology opportunity by integrating capability |
| | of the technology area |
| Collaboration (CL) | Effective utilization of people and management of demand and |
| | supply |
| Branding (BD) | Strong mindshare with analysts and expert groups on the technology |
| | area |
| Benefits—Lag | Organization aims to achieve perfection (PERFECT) |
| indicator | |
| Benefits—Lead | It is a leveraged organization (LEVERAGED) |
| indicator | |
| Customer | QoS & QoE—Both are of high value in each engagement with least |
| | variation |
| | Recognize Integrated Full Service capability |
| | Positive feedback to analysts on organization and associated key |
| | people |
| Employee | Appreciation through QoE |
| | Satisfaction in delivering full service engagement and breadth of skill |
| | Participation in analysts survey and conference presentation |
| Organization | Delivering engagements with certainty |
| | Creating visibility in ecosystem |
| | Continuous gain in productivity |

TABLE 5
Description of the set of capability attributes and description of benefits for the set of
stakeholders at the excite level of maturity:
Maturity Level—Excite (EE) level

| | |
|---|---|
| The set of capability | Organization innovates in the technology area (INNOVATE) |
| attributes | |
| Competency (CM) | Market benchmark and best-in-class recognition |
| Asset (AS) | Creation of Intellectual Property (IP) from assets and its monetization |
| Delivery (DV) | Recognition as best people and organization for delivery |
| Pre-Sale (PS) | Capability to create blue ocean opportunity |
| Collaboration (CL) | Empowered community driving market visibility and creating |
| | opportunities |
| Branding (BD) | Market recognition as a leader in the technology area |
| Benefits—Lag | Organization becomes prime in the technology area (PRIME) |
| indicator | |
| Benefits—Lead | Organization is recognized as Leader in a market place |
| indicator | (LEADER) |
| Customer | Accept the organization as best in class in the technology area |
| | Consult organization and key people for blue ocean discussion and |
| | strategy |
| | Top of the mind recall to discuss the opportunity with the |
| | organization |
| Employee | Authoring international publication |
| | Leading or participating blue ocean discussion |
| | Grooming people as a mentor in the technology area |
| Organization | IP based solution and method |
| | Analysts acceptance as a market leader |
| | Delivering business value to customer |

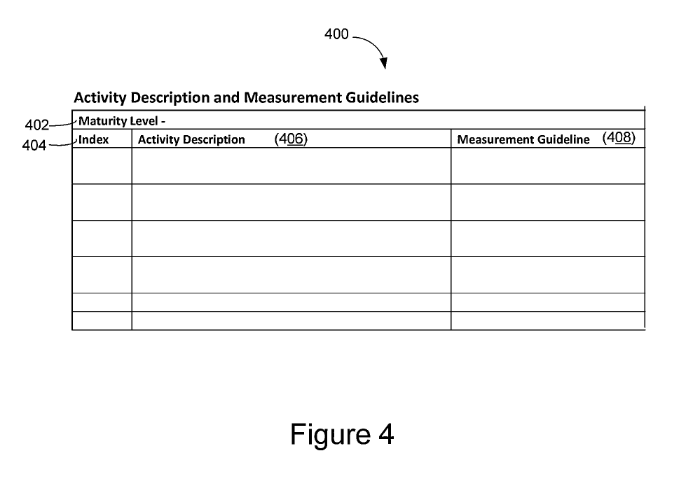

In order to deliver the set capability attributes at each of the maturity levels, TSMM may include a set of activities to be performed by the organization. The set of activities may be measured or assessed using a set of measurement guidelines. In order to systematically describe the set of activities and the set of measurement guidelines, a template 400, as shown in FIG. 4, may be used. The template 400 includes a row 402 for indicating a maturity level, a column 404 for an index, a column 406 for describing the set of activities, and a column 408 for describing the measurement guidelines. In one implementation, the template 400 may be used in Tables 6-10 to describe the set of activities and the set of measurement guidelines for each of the maturity levels. Further, the index indicates a maturity level, a capability attribute, and an activity number. For example, in Table 6, the index includes EM-CM-01, which means that the maturity level is emerge (EM) level, capability attribute is competency (CM), and the activity number is 01.

TABLE 06
Activity description and measurement guidelines for the emerge level:
Maturity Level—Emerge (Activity Description and Measurement Guidelines)

| Index | A set of Activities | Measurement Guidelines |
|---|---|---|
| EM- | Business need justification covering competency | Reviewed ‘Draft Business |
| CM-01 | need—Drafted | Plan’ |
| EM- | Strategy and operating process for building | Reviewed ‘Draft Business |
| CM-02 | competency—Drafted | Plan’ |
| EM- | Business need justification covering asset need— | Reviewed ‘Draft Business |
| AS-01 | Drafted | Plan’ |
| EM- | Operating process to build, use and reference asset— | Reviewed ‘Draft Business |
| AS-02 | Drafted | Plan’ |
| EM- | Identify customer need through business units | Customer/Prospect |
| DV-01 | | Tracking |
| EM- | Build Proof-of-Concept (PoC) with buy-in from | Signed-off PoC |
| DV-02 | business units or customer | Need/Demo |
| EM- | Execute a select set of projects to gain experience | No. of Projects and No. of |
| DV-03 | and expertise | Consultants |
| EM- | Factor market trend/impact/organization direction | Reviewed ‘Draft Business |
| PS-01 | into business need justification | Plan’ |
| EM- | Define process to capture customers' inquiry and | Query/Need tracker & |
| PS-02 | operationalize | resolution |
| EM- | Operationalize the collaboration for training within | Reviewed ‘Draft Business |
| CL-01 | and across business units | Plan’ |
| EM- | Operationalize the collaboration for staffing within | Reviewed ‘Draft Business |
| CL-02 | and across business units | Plan’ |
| EM- | Identification of initial set of key people to support | Community list may |
| BD-01 | pre-sales and delivery | include a group of people |
| | | who wanted to work in the |
| | | technology area and a |
| | | group of people who |
| | | support the project and |
| | | delivery, such as cloud |
| | | computing service |
| | | community in the |
| | | organization. |

TABLE 7
Activity description and measurement guidelines for the engage level:
Maturity Level—Engage (Activity Description and Measurement Guidelines)

| Index | Activity Description | Measurement Guideline |
|---|---|---|
| EN- | Plan & Operationalize training and assessment | Tracker (To check progress) |
| CM-01 | | |
| EN- | Plan and Conduct T3 trainings | Tracker |
| CM-02 | | |
| EN- | Centralize asset inventory in the organization and | Asset Master List (Includes a |
| AS-01 | publish with access control | list of all important assets |
| EN- | Asset gap identification and prioritization | Asset Development/Upgrade |
| AS-02 | | List |
| EN- | Review the need of Multi-service asset (across focus | Multi-service Asset List |
| AS-03 | area) | (Includes composite assets |
| | | covering multiple services to |
| | | address a problem scenario |
| EN- | Build/upgrade/retire asset | Net addition tracker |
| AS-04 | | |
| EN- | Review and update asset bundles—create, add, | Asset bundle tracker |
| AS-05 | modify and delete | |
| EN- | Sign-off Service Level Assurance (For Technical | Community list and Service |
| DV-01 | query) to Delivery team | Level Assurance (SLA) Tracker |
| EN- | Provide support to delivery team in resolving | FAQ update and Query tracker |
| DV-02 | technical/solution query | |
| EN- | Provide framework for estimation (size, productivity | Estimation Guideline—Draft |
| DV-03 | and effort) | |
| EN-PS- | Create pre sale asset-capability deck, Case studies, | Presale bundle checklist |
| 01 | solution framework | |
| EN-PS- | Engage people for pre sale activity—proposal | People list and influence |
| 02 | authoring and presentation | statistics |
| EN- | Asset Upgrade & Development—utilization of | Contribution tracker |
| CL-01 | consultants across units | |
| EN- | Position and use of key asset | No. of assets positioned and |
| BD-01 | | used |
| EN- | Publication of case study | No. of case studies published |
| BD-02 | | |
| EN- | Customer reference on project delivery | List of references available |
| BD-03 | | |

TABLE 8
Activity description and measurement guidelines for the establish level:
Maturity Level—Establish (Activity Description and Measurement Guidelines)

| Index | Activity Description | Measurement Guideline |
|---|---|---|
| ES- | Availability of faculty and training material at all | Faculty list and training deck |
| CM-01 | proficiency level | |
| ES- | On-demand & ‘planned’ delivery of training (alliance | Training tracker |
| CM-02 | support if needed) | |
| ES- | Operationalization of assessment and certification at | Assessment & certification |
| CM-03 | all level | tracker |
| ES- | Continuous improvement on delivery and presale | Target setting and tracking |
| CM-04 | support | |
| ES-AS- | Monitoring of asset utilization—the coverage and | Feedback tracker |
| 01 | improvement areas | |
| ES-AS- | Customer reference on asset impact—both pre sale | Reference tracker |
| 02 | and delivery | |
| ES- | Estimation Framework with Productivity baseline | Estimation Guidelines—Release |
| DV-01 | and improvement target | |
| ES- | Use of solution accelerator in project delivery | Pre-built solution and |
| DV-02 | | productivity |
| ES- | Use of methodology/framework in project delivery | Published Framework/Methods |
| DV-03 | | |
| ES- | Track QoE (Feedback from Customer Senior | Customer Feedback |
| DV-04 | Management) on project delivery | |
| ES- | Incorporate impact of Technology change on | Reviewed Technology Change |
| DV-05 | Delivery | Plan |
| ES-PS- | Track solution/framework led proposal wins | Win/Loss Tracker and Analysis |
| 01 | | |
| ES-PS- | Establish Technology/solution capability as | Win/Loss Tracker and Analysis |
| 02 | differentiators | |
| ES-CL- | SLA based support from Technology community | SLA baseline and target |
| 01 | | |
| ES-BD- | Leverage Alliance relationship in driving | Enablement Plan and Target |
| 01 | competency and certification | |
| ES-BD- | Joint Solution Initiative (with business | Pilot/Anchor customer |
| 02 | units/partners) | |

TABLE 9
Activity description and measurement guidelines for the excel level:
Maturity Level—Excel (Activity Description and Measurement Guidelines)

| Index | Activity Description | Measurement Guideline |
|---|---|---|
| EL- | Completeness and Institutionalization of competency | Define measures and |
| CM-01 | program | governance |
| EL- | Process & action on Customer and Alliance | Feedback/contribution measures |
| CM-02 | feedback/contribution | |
| EL-AS- | Asset bundling based on in-service and cross-service | Asset bundling tracker |
| 01 | ‘need analysis’ | |
| EL-AS- | Create asset bundles to impact on productivity | Measure productivity gain |
| 02 | | |
| EL-AS- | Perform valuation of asset bundles based on usage | Asset Valuation tracker |
| 03 | and business impact | |
| EL- | Delivery experience with integrated service and end- | No. of Case Studies, No. of |
| DV-01 | to-end life cycle | References |
| EL- | Best practice repository—on | Live document on best practices |
| DV-02 | technology/service/methodology | |
| EL- | Articulate business benefit through project/program | Business Benefit Program Sheet |
| DV-03 | delivery | |
| EL- | Contribution to technology excellence/communities | No. of offerings, faculty and T3 |
| DV-04 | | training |
| EL-PS- | Build and Deploy mature pre-sale assets | Improvement in timeline & |
| 01 | | content |
| EL-PS- | Participation in Integrated Full Service solution | No. of large deals— |
| 02 | demonstration | participation & win |
| EL-PS- | Manage solution-based reference | No. of reference customers |
| 03 | | |
| EL-CL- | Consultant positioning—monitoring/improvement at | Tracker & Action/initiative on |
| 01 | community and unit level | gap |
| EL-CL- | Support other communities through ‘asset sharing’ | Influence on community |
| 02 | and mentoring | maturity |
| EL- | Participation in surveys and briefing with | Analysts Reports/Positioning |
| BD-01 | Analysts/Expert groups | |
| EL- | Recognition of Offerings/solution by | Formal feedback/recognition |
| BD-02 | partner/analyst/expert groups | |

TABLE 10
Activity description and measurement guidelines for the excite level:
Maturity Level—Excite (Activity Description and Measurement Guidelines)

| Index | Activity Description | Measurement Guideline |
|---|---|---|
| EE- | Benchmark the Competency Management and role | Competency & progression |
| CM-01 | progression | metrics |
| EE- | Build consultants with multi-service capability | No. of Multi-service consultants |
| CM-02 | | |
| EE-AS- | Drive initiative and process towards | IPRs/Copyrights/Trademark |
| 01 | IPR/trademark/copyright | tracker |
| EE-AS- | Deliberate and Build asset to support blue ocean | Plan and Tracker |
| 02 | strategy | |
| EE- | Operationalize process to have best customer ‘mind | Experience certainty Tracker |
| DV-01 | recall’ | |
| EE- | Assess outcome from Business Benefit Program | Publish and analyze results |
| DV-02 | | |
| EE- | Drive towards ‘partner of choice’ with alliance | Alliance tracker and analysis |
| DV-03 | | |
| EE-PS- | Drive Alliance influence deals (for Organization and | Alliance tracker and analysis |
| 01 | Partner) | |
| EE-PS- | Create opportunity across customers based on | Opportunity Tracker |
| 02 | Business Benefit Program | |
| EE-CL- | Empower community to influence consultant | Governance and Tracker |
| 01 | positioning & market leadership | |
| EE-CL- | Benchmark collaboration with external and internal | Benchmark tracker |
| 02 | ecosystem | |
| EE-CL- | Establish Innovative KM (content and collaboration) | Identify measures and track |
| 03 | practices | |
| EE- | Participation in conferences as speakers/Publish | Tracker |
| BD-01 | articles in key journals/media | |
| EE- | Global recognition of consultants and assets | Track recognition |
| BD-02 | | |

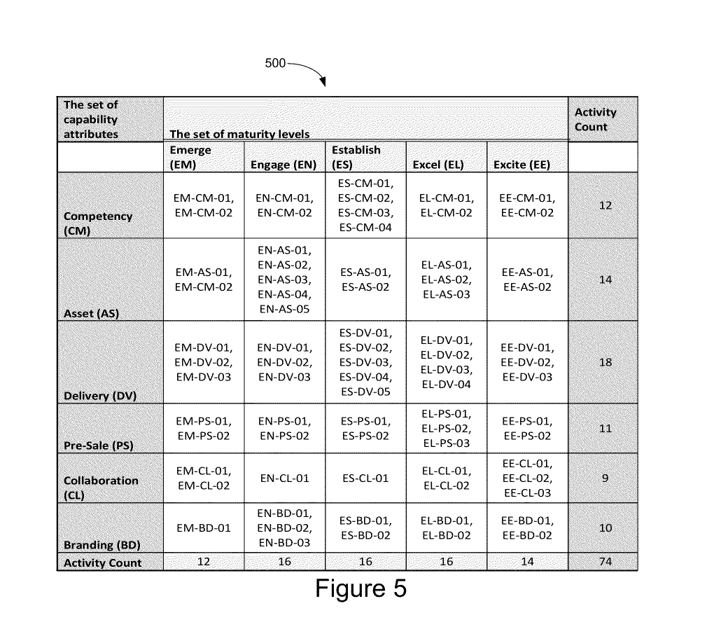

Tables 6-10 show that each of the activities is indexed by factoring the set of capability attributes and a maturity level it represents. The set of activities may be collated for a given capability attribute and for a given maturity level as shown in FIG. 5. Specifically, FIG. 5 shows a table 500 for determining count of activities to be performed for a given maturity level and a given capability attribute. In one implementation, the table shown in FIG. 5 may be generated by the definition module 118.

After set of the activities are defined for each of the capability attributes for each of the maturity levels, the organization may start performing the set of activities in order to get mature in a technology area. The performance of the organization in completing the set of activities for each of the capability attributes may be used to assess a maturity status of the organization in the technology area. Further, the maturity status of the organization may also depend upon the assets created by the organization while performing the set of activities. In one implementation, the performance of the organization may be assessed using a set of rules defined by the assessment module 120. Based on the set of rules, assessment reports shown in FIG. 6A-6C may be generated by the report module 122.

In one implementation, the set of rules may include ten rules. According to rule 1, an assessment report may be in a form of a matrix 600 having maturity levels in a first axis and the set of capability attributes in a second axis as shown in FIGS. 6A-6C. The matrix 600 may include a cell value 602, a column sum 604, a row maturity status 606, a final maturity status 608, and a matrix score 610 as shown in FIG. 6B.

According to rule 2, the cell value for emerge level has a maximum limit of 1, the cell value for engage level has a maximum limit of 2, the cell value for establish level has a maximum limit of 3, the cell value for excel level has a maximum limit of 4, and the cell value for excite level has a maximum limit of 5. Further, according to rule 3, the cell value in each cell is on a gradation from 0%, 25%, 50%, 75% and 100% of the maximum limit of a cell value. FIG. 6A shows that the maximum possible score an organization can receive in each cell.

According to rule 4, as shown in FIG. 6B, cells having cell values of 0%, 25% and 50% of the maximum limit will have a first type of visual marking. Further, cells having cell values of 75% of the maximum limit may have a second type of visual marking. Furthermore, cells having cell values of 100% of the maximum limit may have a third type of visual marking.

According to rule 5, if a cell has a first type of visual marking, then a corresponding column sum and a corresponding maturity level will have the first type of visual marking irrespective of the cell values in the other cells in the same column. For example, FIG. 6B shows that column 5 contains cells having the first type of visual marking, therefore the corresponding column sum and the corresponding maturity level i.e. ‘excel’ will have the first type of visual marking irrespective of the cell values in the other cells in the same column.

According to rule 6, if a cell X has a first type of visual marking, then all the cells Y in right of the cell X and in the same row will be have the first type of visual marking irrespective of the cell values in the cells Y. For example, FIG. 6B shows that since a cell 612 has a first type of visual marking, a cell 614 also has the first type of visual marking irrespective of a fact that the cell 614 has a cell value of 100%. Further, rule 6 also requires that the row maturity status is denoted by the maturity level of a column with no cell having the first type of visual marking. In one example, if the first type visual marking is a red color, then the row maturity status is denoted by the maturity level of a last non-red cell that is not preceded by any red cell in a same row.

According to rule 7, if all of the set of capability attributes in a maturity level have 100% cell values, then a bonus score for the same maturity level is 2.0 as show in FIGS. 6A-6C. Further, according to rule 8, a maturity status of the organization in a given technology area is of a column with no cell having the first type of visual marking. In one example, if the first type of visual marking is a red color, then the maturity status of the organization is the maturity level of a right most non-red column sum. Further, rule 8 also requires that the matrix score is an aggregate of all column sums having either second type of visual marking or third type of visual marking. In one example, if the first type of visual marking is red, then the matrix score is an aggregate of all non-red column sums.

Further, rules 9 and 10 are primarily related to governance of maturity progress in the organization. Specifically, rule 9 requires that each technology area group in the organization should use report module 122 to generate the assessment reports 600 as shown in FIGS. 6A-6C on a quarterly basis. Further, rule 9 also requires that the assessment reports 600 get published on a dashboard and should be analyzed by the analytics module 124 to determine weak points and to plan value enhancement and maturity movement from emerge level to excite level. Further, according to rule 10, the quarterly produced assessment reports 600 should be analyzed by the analytics module 124 to determine a pattern of weak points, a pattern of good points, and may therefore help in taking corrective actions. Further, rule 10 also requires that new technology areas are also assessed for maturity. The assessment reports 600 may be used for taking pro-active actions for alignment of focus of the organization and for continuous improvement.

While the assessment of the maturity level of an organization by the assessment module 120 has been described with reference to certain specific rules, it will be understood that these are merely examples, and different rules may be used based on the requirements of the organization.

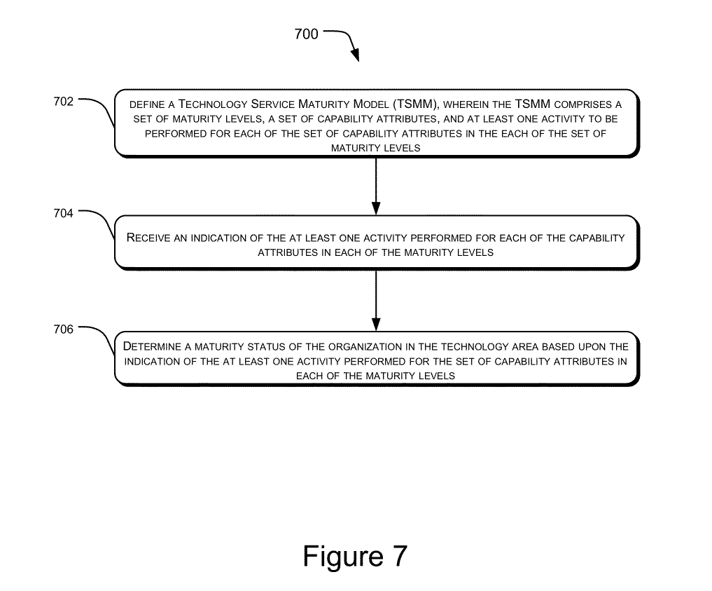

Referring now to FIG. 7, a method 700 for determining a maturity status of an organization in a technology area is shown, in accordance with an embodiment of the present subject matter. The method 700 may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the subject matter described herein. Furthermore, the method can be implemented in any suitable hardware, software, firmware, or combination thereof. However, for ease of explanation, in the embodiments described below, the method 700 may be considered to be implemented in the above described system 102.

At block 702, a Technology Service Maturity Model (TSMM) is defined. The TSMM may include a set of maturity levels indicating at least one of an aspired proficiency level and a current proficiency level of the organization in the technology area. The TSMM may further include a set of capability attributes for each of the maturity levels. Furthermore, the TSMM may include at least one activity to be performed for each of the capability attributes in the each of the maturity levels. In one implementation, TSMM may be defined by the definition module 118.

At block 704, an indication of the at least one activity performed for each of the capability attributes in each of the maturity levels is received. In one example, the indication is received by the assessment module 120.

At block 706, a maturity status of the organization in the technology area is determined based upon the indication of the at least one activity performed for the set of capability attributes in each of the maturity levels. In one example, the maturity status of the organization is determined by the assessment module 120.

Although implementations for methods and systems for determining a maturity status of an organization in a technology area have been described in language specific to structural features and/or methods, it is to be understood that the appended claims are not necessarily limited to the specific features or methods described. Rather, the specific features and methods are disclosed as examples of implementations for determining a maturity status of an organization in a technology area.

I/We claim:

1. A system for determining a maturity status of an organization in a technology area, the system comprising:
a processor; and
a memory coupled to the processor, the memory comprising
a definition module configured to define a Technology Service Maturity Model (TSMM) comprising
a set of maturity levels indicating at least one of an aspired proficiency level and a current proficiency level of the organization in the technology area; and
a set of capability attributes for each of the maturity levels, wherein the set of capability attributes comprises at least one of competency, asset, delivery, pre-sales, collaboration, and branding; and
an assessment module configured to determine the maturity status of the organization in the technology area based upon the set of capability attributes possessed by the organization in the each of the maturity levels.

2. The system of claim 1, wherein the TSMM further comprises a benefit dimension indicating benefits for a set of stakeholders comprising at least one of an employee of the organization, a customer of the organization, and the organization.

3. The system of claim 2, wherein the benefit dimension is associated with lag indicators and lead indicators, and wherein the lag indicator are based on a 5P maturity model comprising presence, penetration, performance, perfect, and prime, and wherein the lead indicators are based on a 5L maturity model comprising learning, leveraging, learned, leveraged and leader.

4. The system of claim 1, wherein the set of maturity levels comprises at least one of an emerge level, an engage level, an establish level, an excel level, and an excite level.

5. The system of claim 4, wherein the TSMM further comprises a 5I maturity model for developing the set of capability attributes for the organization in the each of the maturity levels, and wherein in the 5I maturity model, the organization
shows an intent to develop the set of capability attributes in the emerge level, makes initiations to develop the set of capability attributes in the engage level, drives initiatives to develop the set of capability attributes in the establish level,
ensures internalization of the initiatives across the organization with equal effectiveness by building the set of capability attributes to achieve excel level, and
starts practicing innovation by developing the set of capability attributes in the excite level.

6. The system of claim 1, wherein the TSMM further comprises at least one activity for each of the capability attributes in the each of the maturity levels, wherein the at least one activity is performed by the organization.

7. The system of claim 6, wherein the TSMM further comprises at least one measurement guideline for measuring at least one activity, wherein the at least one measurement guideline assist in determining the maturity status of the organization in the technology area.

8. The system of claim 1, wherein the assessment module (120) is further configured to define a set of rules to determine the maturity status of the organization in the technology area.

9. The system of claim 8, further comprising
a report module configured to generate assessment reports based on the set of rules; and
an analytics module configured to determine at least one of a pattern of weak points and good points of the organization in the set of maturity levels.

10. A method for determining a maturity status of an organization in a technology area, the method comprising:
defining a Technology Service Maturity Model (TSMM) comprising
a set of maturity levels indicating at least one of an aspired proficiency level and a current proficiency level of the organization in the technology area;
a set of capability attributes for each of the maturity levels; and
at least one activity to be performed for each of the capability attributes in the each of the maturity levels; and
determining the maturity status of the organization in the technology area based upon the at least one activity and the set of capability attributes possessed by the organization in the each of the maturity levels.

11. The method of claim 10, wherein the set of capability attributes comprises at least one of competency, asset, delivery, pre-sales, collaboration, and branding, and wherein the set of maturity levels comprises at least one of an emerge level, an engage level, an establish level, an excel level, and an excite level.

12. The method of claim 10, wherein the TSMM further comprises a benefit dimension indicating benefits for a set of stakeholders comprising at least one of an employee of the organization, a customer of the organization, and the organization, and wherein the benefit dimension is associated with lag indicators and lead indicators, and wherein the lag indicators are based on a 5P maturity model comprising presence, penetration, performance, perfect, and prime, and wherein the lead indicators are based on a 5L maturity model comprising learning, leveraging, learned, leveraged and leader.

13. The method of claim 10, wherein the TSMM further comprises at least one measurement guideline for measuring the at least one activity, wherein the at least one measurement guideline assist in determining the maturity status of the organization in the technology area.

14. The method of claim 10, further comprising defining a set of rules to determine the maturity status of the organization in the technology area.

15. The method of claim 14, further comprising generating assessment reports based on the set of rules, wherein the assessment reports comprises a cell value, an aggregate column value, a row maturity status, a matrix score, a bonus score, and the maturity status.

16. The method of claim 14, wherein the set of rules includes rules for determining
a maximum score for each of the capability attributes in each of the maturity levels,
a bonus score for each of the capability attributes in each of the maturity levels, and
a passing percentage for each of the capability attributes in each of the maturity levels.

17. A computer-readable medium having embodied thereon a computer program for executing a method for determining a maturity status of an organization in a technology area, the method comprising:
defining a Technology Service Maturity Model (TSMM) comprising
a set of maturity levels indicating at least one of an aspired proficiency level and a current proficiency level of the organization in the technology area;
a set of capability attributes for each of the maturity levels; and
at least one activity for each of the capability attributes in the each of the maturity levels; and
determining the maturity status of the organization in the technology area based upon the at least one activity and the set of capability attributes possessed by the organization in the each of the maturity levels.

18. The method of claim 17, wherein the set of capability attributes comprises at least one of competency, asset, delivery, pre-sales, collaboration, and branding, and wherein the set of maturity levels comprises at least one of an emerge level, an engage level, an establish level, an excel level, and an excite level.

19. The method of claim 17, wherein the TSMM further comprises a benefit dimension indicating benefits for a set of stakeholders comprising at least one of an employee of the organization, a customer of the organization, and the organization, and wherein the benefit dimension is associated with lag indicators and lead indicators, and wherein the lag indicators are based on a 5P maturity model comprising presence, penetration, performance, perfect, and prime, and wherein the lead indicators are based on a 5L maturity model comprising learning, leveraging, learned, leveraged and leader.

20. The method of claim 17, wherein the TSMM further comprises at least one measurement guideline for measuring the at least one activity, wherein the at least one measurement guideline assist in determining the maturity status of the organization in the technology area.
